(19) United States
(12) Patent Application Publication
(10) Pub. No.: US 2012/0276364 A1
(43) Pub. Date: Nov. 1, 2012

(54) Structural Sandwich Panel and Method of Manufacture Thereof

(76) Inventors: Stephen Kennedy, Ottawa (CA); Neil Little, Buckinghamshire (GB)

(21) Appl. No.: 13/519,985

(22) PCT Filed: Dec. 23, 2010
(86) PCT No.: PCT/GB10/02332

§ 371 Date: Jun. 29, 2012

(30) Foreign Application Priority Data
Jan. 5, 2010 (GB) 1000124.6

(51) Int. Cl. B32B 5/18; B32B 27/40; B32B 37/00; B32B 15/08

(52) U.S. Cl. 428/304.4; 428/411.1; 428/423.1; 156/305

(57) ABSTRACT

A standard sandwich panel has forms within its core. The forms are made of a lightweight material that is hydrophobic, e.g. polyisocyanurate. The rest of the core is made of a material that has sufficient strength to transfer shear forces between faceplates of the panel. The main core material can be a compact thermoplastic elastomer.

The present invention relates to methods of construction of vessels, such as ships, barges or boats, and structures such as buildings, bridges and off-shore structures.

Structural sandwich plate members are described in U.S. Pat. No. 5,778,813 and U.S. Pat. No. 6,050,208, which documents are hereby incorporated by reference, and comprise outer metal, e.g. steel, plates bonded together with an intermediate elastomer core, e.g. of unfoamed polyurethane. These sandwich plate systems (SPS) may be used in many forms of construction to replace stiffened steel plates, formed steel plates, reinforced concrete or composite steel-concrete structures and greatly simplify the resultant structures, improving strength and structural performance (e.g. stiffness, damping characteristics) while saving weight.

Further developments of these structural sandwich plate members are described in WO 01/32414, also incorporated hereby by reference. As described therein, hollow or solid forms may be incorporated in the core layer to reduce weight and transverse metal shear plates may be added to improve stiffness. Hollow forms generate a greater weight reduction than solid forms and are therefore often advantageous. The forms may be made of lightweight foam material or other materials such as wood or steel boxes, plastic extruded shapes and hollow plastic spheres.

It is an aim of the present invention to provide a sandwich panel with foam forms in the core that can be manufactured more reliably and has controllable physical properties. In particular it is desirable to ensure consistent bonding throughout the core.

According to the present invention there is provided a sandwich panel comprising:
a first plate and a second plate spaced apart from the first plate; and
a core bonded to the first and second metal plates so as to transfer shear forces therebetween, the core comprising a main core material and a plurality of forms made of a lightweight material that is less dense than the main core material;
wherein the lightweight material is hydrophobic.

According to another aspect of the invention there is provided a method of manufacturing a sandwich panel, the method comprising:
providing first and second plates in a spaced apart relation with a plurality of forms made of a lightweight material disposed therebetween;
substantially filling the space between the first and second plates not occupied by the lightweight forms with a main core material so that it bonds to the first and second plates with sufficient strength to transfer shear forces therebetween,
wherein the lightweight material is less dense than the main core material and is hydrophobic.

The present invention will be described below with reference to exemplary embodiments and the accompanying drawings, in which:

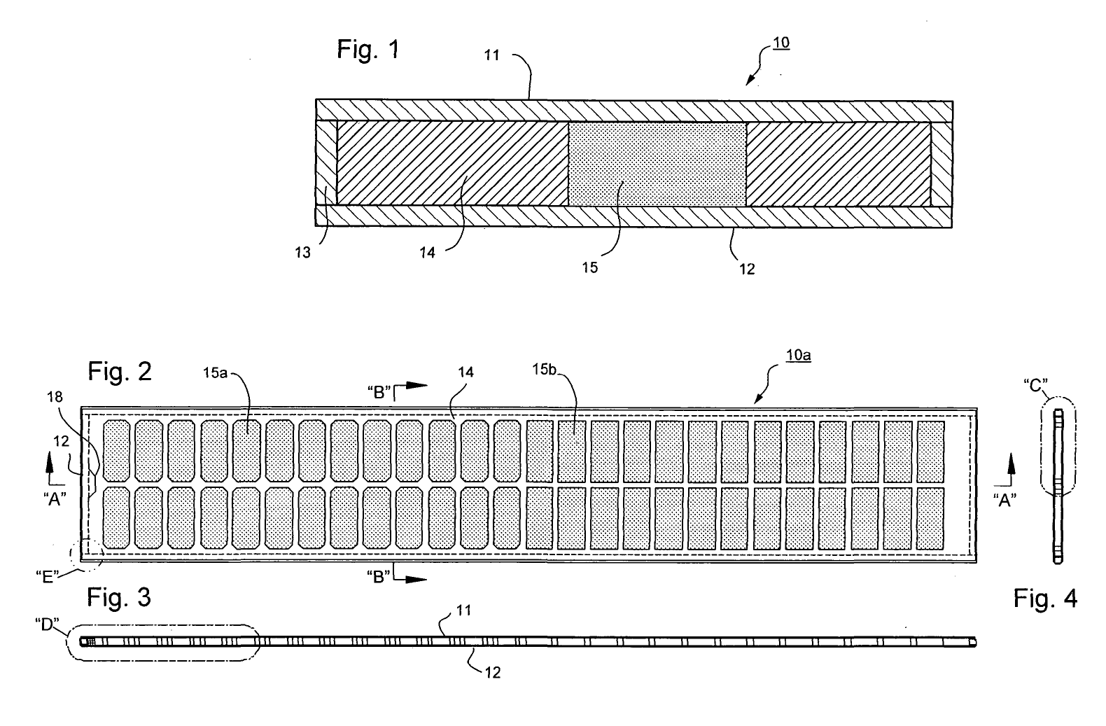

FIG. 1 is a schematic cross-section of a prefabricated SPS panel according to an embodiment of the present invention;

FIG. 2 is a horizontal cross-sectional view of another prefabricated SPS panel in according to an embodiment of the invention;

FIG. 3 is a vertical cross-sectional view of the panel of FIG. 2 along the line “A-A”;

FIG. 4 is a vertical cross-sectional view the panel of FIG. 2 along the line “B-B”;

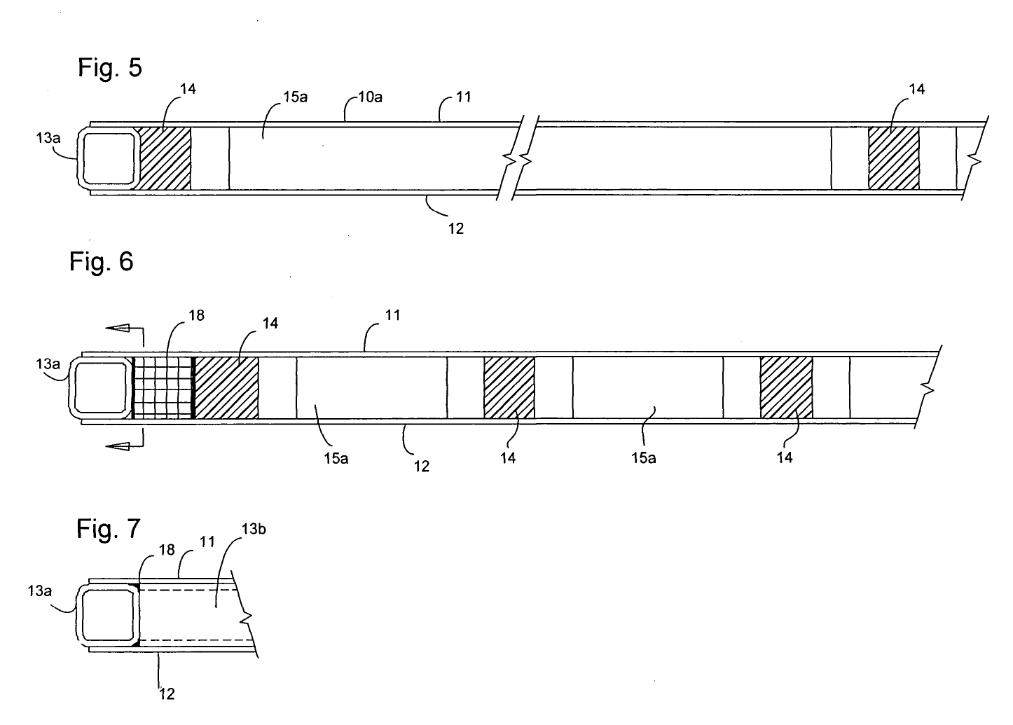

FIG. 5 is an enlarged cross-sectional view of the part ringed “C” in FIG. 4;

FIG. 6 is an enlarged cross-sectional view of the part ringed “D” in FIG. 3;

FIG. 7 is an enlarged cross-sectional view of the part ringed “E” in FIG. 2; and

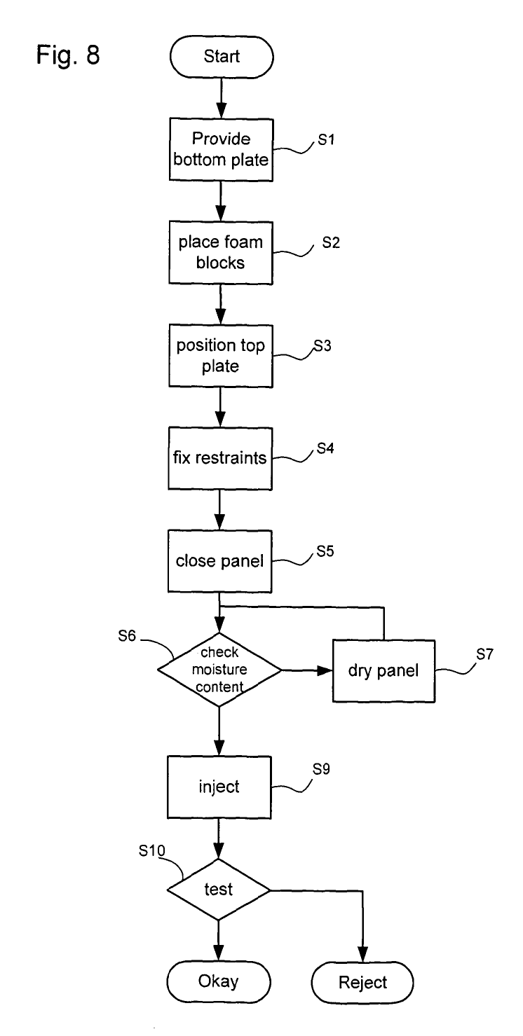

FIG. 8 is a flow diagram of a method of manufacturing an SPS panel according to an embodiment of the invention.

In the various drawings, like parts are indicated by like reference numerals.

The present inventors have discovered that with lightweight forms made from certain foam materials it is difficult to reliably manufacture an SPS panel member. In particular, the inventors have discovered that certain foam materials cause excessive voids to be formed in the main core material when it is cast in the cavity defined by the outer plates of the SPS panel. Investigation has revealed that by making the lightweight forms out of a hydrophobic material, the adsorption of water onto the surface of the forms is avoided. Water adsorbed onto the surface of forms has been found to react with the core material, causing foaming. This foaming was found to be the cause of excessive voids and incomplete bonding of the core to the outer plates in comparative tests. Thus, by using a lightweight hydrophobic material for the forms foaming can be avoided and a satisfactory bond between outer plates and core assured.

In an embodiment, the lightweight material has a contact angle to water of greater than 90 degrees, preferably greater than 95 degrees, preferably greater than 100 degrees, more preferably greater than 110 degrees. The contact angle required to assure a satisfactory bond may depend on the specific circumstances of an application, in particular the atmospheric conditions experienced during manufacture.

A particularly useful lightweight material is a polyisocyanurate (PIR) foam. This has additional advantages in that it is cheap, readily available, easy to handle and easy to cut in to appropriate shapes.

In an embodiment, the forms are substantially rectangular in plan. They may have a longest dimension in a direction parallel to the first plate that is in the range of from 200 to 800 mm and a shortest dimension in a direction parallel to the first plate that is in the range of from 90 mm to 360 mm. The forms may be spaced apart in a direction parallel to the first plate, e.g. such that a distance between adjacent forms in a direction parallel to the first plate is in the range of from 20 mm to 80 mm. Such dimensions and spacing provide an appropriate amount and distribution of the core material to ensure shear forces are transferred between the plates. The dimensions may be chosen according to the expected loads and weight requirements of the application to which the panels are to be put. If a lighter panel is desired, the size of forms may be increased and the spacing between them decreased. For a stronger panel, the forms are reduced in size and the spacing between them increased.

Desirably, the lightweight forms have a thickness substantially equal to the distance between the first and second plates. This ensures that the heavier main core material is concentrated in defined regions spanning between the outer plates and ensures that its contribution to the strength of the panel is maximised. A thin layer of the main core material between a form and one of the outer plates would add weight without adding strength.

In an embodiment, at least one of the forms has a rigid spacer embedded therein. The rigid spacer serves to support the upper one of the two plates during formation of the core and to maintain the required spacing between the plates. Embedding it in a form enables it to be placed quickly and accurately. The spacer is desirably strong enough to support the upper plate and any restraining weights that may be used to control expansion of the main core material during casting thereof.

The materials, dimensions and general properties of the outer plates of the SPS panels used in the invention may be chosen as desired for the particular use to which they are to be put. Steel or stainless steel may be used in thicknesses of 0.5 to 20 mm and aluminium may be used where light weight is desirable. Similarly, the plastics or polymer core may be any suitable material, for example an elastomer such as polyurethane, and is preferably compact, i.e. not a foam. The core is preferably a thermosetting material rather than thermoplastic.

FIG. 1 shows an SPS panel 10 that can be used in embodiments of the invention. The panel preferably presents generally outer surfaces but the outer surfaces need not be flat and either or both surfaces may be provided with recesses, trenches, grooves and/or fittings if required. The panel as a whole may be curved or otherwise shaped if desired. Injection parts and vent holes may be provided for manufacture but are desirably sealed and/or ground flush after use. In plan the panel is desirably substantially rectangular but panels of other shapes may be used if desired.

The panel 10 shown in FIG. 1 is a structural sandwich plate member that comprises upper and lower outer plates (faceplates) 11, 12 which may be of steel, stainless steel or aluminium and have a thickness, for example, in the range of from 3 to 8 mm, more preferably 3 to 5 mm. Edge members 13 (also referred to as perimeter bars), described further below, are provided between the face plates 11, 12 around their outer peripheries to form a closed cavity. In the cavity between the face plates 11, 12 is a core 14, described further below. This core may have a thickness in the range of from 15 to 200 mm. In building applications such as floor panels, 20 to 80 mm is preferable. In maritime applications 20 mm to 30 mm is preferable. The overall dimensions of the panel in plan may be from 1 to 3 m width by 2 to 14 m length. Panels may be made in standard sizes or tailor-made to specific shapes and/or dimensions.

The core may take various different forms but its major structural component is a main core layer 14 of plastics or polymer material (preferably comprising or consisting essentially of a thermoset, compact elastomer such as polyurethane as discussed above) which is bonded to the face plates 11, 12 with sufficient strength and has sufficient mechanical properties to transfer shear forces expected in use. The bond strength between the layer 14 and face plates 11, 12 should be greater than 3 MPa, preferably greater than 6 MPa, and the modulus of elasticity of the core material should be greater than 200 MPa, preferably greater than 250 MPa. Alternatively, the core 14 may be a concrete layer. The concrete layer may be normal concrete which typically weighs about 2400 kg/m³ (e.g. between 2100 and 2700 kg/m³), but preferably light weight concrete which typically weighs about 1900 kg/m³ (e.g. between 1200 and 2200 kg/m³), more preferably ultra light weight concrete that typically weighs about 1200 kg/m³ or less (e.g. between 500 and 1200 kg/m³). The concrete may be of any type of cementitious material (e.g. cements such as Portland cement, fly ash, ground granulated blast furnaces slags, limestone fines and silica fume).

The core 14 also includes at least one lightweight form 15. The size and material of the form(s) are chosen so that the overall density of the forms is lower than the density of the material of the main core, preferably less than 50% of the density of the material of the core layer 14, or preferably less than 25% and most preferably less than 10%. Suitable materials are discussed further below. The purpose of the forms is essentially to take up space within the core and thus reduce the amount of the main core material required whilst maintaining or even increasing the desired spacing between faceplates 11 and 12. This reduces cost both directly as the forms are less expensive by volume than the main core material and secondly because the weight of the panels is reduced. The forms do not need to contribute to the overall structural strength of the floor panel 10 but if the panel 10 is formed by injection of the main core layer 14, the forms must have physical properties sufficient to withstand pressures and temperatures arising during casting and curing of the main core layer 14. The size, shape and distribution of forms 15 within the core is chosen so that a sufficient number of ribs and/or columns of main core layer material extend between and bond to faceplates 11 and 12 at regular intervals across the length and width of the panel 10.

An edge member 13 is provided in at least one, preferably all edges of panel 10. Edge member 13 may be a solid bar of metal having a generally constant cross-section throughout its length. It may therefore be described as prismatic. In an embodiment of the invention, edge member 13 projects outwardly of the faceplates 11, 12 and is shaped to facilitate welding of the panel into a framework.

Another embodiment of the invention will now be described with reference to FIGS. 2 to 7. FIG. 2 is a cross-sectional plan view of a prefabricated sandwich panel 10a whilst FIGS. 3 and 4 are cross-sectional views along lines A-A and B-B in FIG. 2 respectively. FIGS. 5 to 7 are enlargements of the parts ringed and labelled C, D and E in FIGS. 4, 3 and 2 respectively.

The sandwich panel 10a shown in these Figures is a panel suitable for use as a floor panel in a steel-framed building fabricated as a test sample. Sandwich panel 10a measures about 6 m by 1 m and has upper metal plate 11 of thickness 4 mm, a solid core 14 of thickness 50 mm and a lower metal plate 12 of thickness 4 mm. As described above, upper and metal plates 11, 12 may be of steel and core 14 may be of compact thermoset polyurethane elastomer.

Within the core of the panel 10a, an array of forms 15 of lightweight material are provided. These forms may be made of rigid polyisocyanurate (PIR) foam, for example that manufactured under the product code FR4000 by Celotex Limited of Ipswich, United Kingdom. This foam is manufactured for use in insulating roof spaces and as such is provided with textured aluminium facings to improve its thermal performance. These facings are unnecessary in the present invention but neither is their presence detrimental. An alternative foam material that may be used in the invention is extruded polystyrene. Compared to expanded polystyrene, extruded polystyrene has a much lower moisture absorbency, in some cases an order of magnitude less.

The PIR foam forms have thickness equal to the spacing between outer plates 11, 12, e.g. 50 mm. Different thicknesses may be used where a different thickness panel is to be made. The PIR foam forms have dimensions in plan of about 180 mm by 400 mm but these may be varied as desired to suit expected load conditions and weight requirements for the intended application of the panel. The percentage of the core occupied by the lightweight forms can therefore be adjusted as desired. In an embodiment, the percentage of the core occupied by forms is greater than 20%, greater than 30%, greater than 40%, greater than 50%, and desirably greater than 60%. In an embodiment, the percentage is desirably less than 90%, less than 80% and less than 70%.

As shown in FIG. 2, half of the forms 15a have chamfered corners, the remaining half 15b do not. The chamfered corners aid flow of the main core material when the cavity is filled but do not materially affect the structural properties of the panel. Corners of the forms 15 may instead be rounded.

Panel 10a is arranged to be filled with main core material from a single injection port 17 at one end of the panel. Vent holes (not shown) are provided at the opposite end of the panel. A diffuser 18 is provided inside the panel opposite the injection port 17 to prevent the inflowing core material displacing the pre-placed forms 15. The deflector may be a plate fixed to one or both of the outer metal plates 11, 12 or a mesh as can be seen more clearly in FIG. 6.

As shown in FIG. 5, edge member or perimeter bar 13a, which defines the long side of the cavity to be filled with the core, is a 50 mm by 50 mm hollow steel tube of substantially square section and wall thickness 5 mm. Gasket tape, not shown, may be provided between the edge member 13a and upper and lower plates 11, 12 to improve sealing of the cavity. Edge member 13a may be welded to the outer plates before or after formation of the core. In some applications edge member 13a may be held in place by adhesive and/or the main core material, without welding to the outer plates. Edge member 13a may protrude a predetermined distance out of the edge of the outer plates in order to facilitate positioning the panel 10a adjacent similar panels or another part of a structure. The protrusion facilitates welding the outer plates of the panel 10a to the outer plates of an adjacent panel or another part of a structure.

Edge member 13b, best seen in FIG. 6, closes the short side of the cavity. It is similar to edge member 13a and can be fixed in the same way. At the corner, shown in FIG. 7, joint compound 19, e.g. Hylomar Universal Blue™ available from Hylomar Limited, Wigan, UK, can be used to ensure the cavity is sealed.

FIG. 8 is a flow diagram of a preferred method of constructing a panel according to the invention, which is preferably performed in factory conditions. First the lower plate 12 is provided S1 and edge members 13a, 13b laid out around the perimeter thereof, with any necessary gasket or sealants. Then the PIR foam forms are laid out S2 on top of the lower plate along with any required spacers (which may be embedded in the PIR foam forms in advance). Next the upper plate 11 is placed on top to create the cavity which will be filled with the main core material. At this point any restraints, e.g. weights, required to hold the top panel flat during the cavity filling procedure may be fixed S4 and the panel closed S5, e.g. by welding. If the panel is formed in a mould, fixing of restraints and welding the panel can be omitted.

Prior to filling of the cavity with the main core material, it is desirable to measure the moisture content of the cavity and/or the air remaining in the cavity. If the measured level is too high, the cavity may be dried by flushing through with clean dry air or gas and/or evacuating the cavity. In this way foaming caused by reaction of water in the cavity with the main core material can be avoided and correct bonding achieved.

Filling of the cavity S9 with core material can be performed by reaction injection moulding (RIM) or vacuum filling methods. The main core material is then allowed to set or cure to form the main core layer 14. After curing, the injection ports and vent holes are filled, e.g. with threaded or welded plugs, and ground flush with the surface of the edge member. It is to be noted that even if a single continuous cavity is present prior to injection, multiple injection ports and vent holes may be provided to ensure complete filling.

A test panel manufactured in accordance with the above described method and in accordance with FIGS. 2 to 7 was shown to have satisfactory bonding of the core to the outer metal plates and achieved design strength. Other, similar test panels using lightweight forms of polypropylene and polystyrene blocks did not. Even though these materials are only slightly hydrophilic, it was determined that surprisingly sufficient water was adsorbed onto the surfaces of the blocks to cause foaming when the core was injected. This was not expected and to discover it it was necessary to cast test panels with Perspex outer plates so that the behaviour of the core materials could be observed during formation of the core.

If the panel is to be provided with recesses, grooves or other surface features, such as fixing or lifting points, these are preferably formed in or on the outer metal plates prior to formation of the core. Grooves and other indentations can be formed by known techniques such as milling, cutting, bending, rolling and stamping as appropriate to the thickness of the plate and size of feature to be formed. Details can be attached by welding. It is also possible to form such features after curing of the main core layer 14 but in that case measures may need to be taken to ensure that the heat generated by activities such as welding does not deleteriously affect the core 14.

In some circumstances it may be possible to avoid the use of a mould by welding edge plates or perimeter bars to the outer metal plates so that the panel forms its own mould. Depending on the compressibility and resilience of the inner core, it may be necessary to provide restraints to prevent deformation of the outer metal plates due to the internal pressures experienced during injection and for curing of main core layer 14.

It should be noted that after the core has cured, the faceplates and perimeter bars are bound together by the core 14 so that in some cases the fixing of the perimeter bars to the face plates need only be sufficient to withstand loads encountered during the injection and/or curing steps, and not necessarily loads encountered during use of the floor panel 10. To improve sealing of the cavity, gaskets or sealing strips can be provided between the edge plates or perimeter bars and faceplates.

It will be appreciated that the above description is not intended to be limiting and that other modifications and variations fall within the scope of the present invention, which is defined by the appended claims. In various drawings, hatching has in some cases been omitted and in other cases different directions of hatching have been used for clarity. This should not be taken as indication that material types are not critical nor that different materials are necessarily used.

1-32. (canceled)

33. A sandwich panel comprising:
a first plate and a second plate spaced apart from the first plate; and
a core bonded to the first and second metal plates so as to transfer shear forces therebetween, the core comprising a main core material and a plurality of forms made of a lightweight material that is less dense than the main core material;
wherein the lightweight material is hydrophobic.

34. A sandwich panel according to claim 33 wherein the lightweight material has a contact angle to water of greater than 90 degrees, preferably greater than 95 degrees, preferably greater than 100 degrees, more preferably greater than 110 degrees.

35. A sandwich panel according to claim 33 wherein the lightweight material is a polyisocyanurate foam.

36. A sandwich panel according to claim 33 wherein the lightweight material is an extruded polystyrene foam.

37. A sandwich panel according to claim 33 wherein the forms are substantially rectangular in plan.

38. A sandwich panel according to claim 33 wherein the forms have a longest dimension in a direction parallel to the first plate that is in the range of from 200 to 800 mm.

39. A sandwich panel according to claim 33 wherein the forms have a shortest dimension in a direction parallel to the first plate that is in the range of from 90 mm to 360 mm.

40. A sandwich panel according to claim 33 wherein the forms are spaced apart in a direction parallel to the first plate.

41. A sandwich panel according to claim 40 wherein a distance between adjacent forms in a direction parallel to the first plate is in the range of from 20 mm to 80 mm.

42. A sandwich panel according to claim 33 wherein the lightweight forms have a thickness substantially equal to the distance between the first and second plates.

43. A sandwich panel according to claim 33 wherein at least one of the forms has a rigid spacer embedded therein.

44. A sandwich panel according to claim 33 wherein the main core material is a compact material.

45. A sandwich panel according to claim 33 wherein the main core material is a thermoset material.

46. A sandwich panel according to claim 33 wherein the main core material is polyurethane.

47. A sandwich panel according to claim 33 wherein the first and second plates are made of metal.

48. A sandwich panel according to claim 47 wherein the first and second plates are each made of a metal selected from the group consisting of: steel, stainless steel and aluminium.

49. A method of manufacturing a sandwich panel, the method comprising:
providing first and second plates in a spaced apart relation with a plurality of forms made of a lightweight material disposed therebetween;
substantially filling the space between the first and second plates not occupied by the lightweight forms with a main core material so that it bonds to the first and second plates with sufficient strength to transfer shear forces therebetween,
wherein the lightweight material is less dense than the main core material and is hydrophobic.

50. A method according to claim 49 wherein the lightweight material has a contact angle to water of greater than 90 degrees, preferably greater than 95 degrees, preferably greater than 100 degrees, more preferably greater than 110 degrees.

51. A method according to claim 49 wherein the lightweight material is a polyisocyanurate foam.

52. A method according to claim 49 wherein the lightweight material is an extruded polystyrene foam.

53. A method according to claim 49 wherein the forms are substantially rectangular in plan.

54. A method according to claim 49 wherein the forms have a longest dimension in a direction parallel to the first plate that is in the range of from 200 to 800 mm.

55. A method according to claim 49 wherein the forms have a shortest dimension in a direction parallel to the first plate that is in the range of from 90 mm to 360 mm.

56. A method according to claim 49 wherein the forms are spaced apart in a direction parallel to the first plate.

57. A method according to claim 56 wherein a distance between adjacent forms in a direction parallel to the first plate is in the range of from 20 mm to 80 mm.

58. A method according to claim 49 wherein the lightweight forms have a thickness substantially equal to the distance between the first and second plates.

59. A method according to claim 49 wherein at least one of the forms has a rigid spacer embedded therein.

60. A method according to claim 49 wherein the main core material is a compact material.

61. A method according to claim 49 wherein the main core material is a thermoset material.

62. A method according to claim 49 wherein the main core material is polyurethane.

63. A method according to claim 49 wherein the first and second plates are made of metal.

64. A method according to claim 63 wherein the first and second plates are each made of a metal selected from the group consisting of: steel, stainless steel and aluminium.
